(19) United States
(12) Patent Application Publication
(10) Pub. No.: US 2026/0083180 A1
(43) Pub. Date: Mar. 26, 2026

(54) METHOD FOR CONTROLLING ATOMIZATION DEVICE, ATOMIZATION DEVICE, AND READABLE STORAGE MEDIUM

(71) Applicant: SHENZHEN SMOORE TECHNOLOGY LIMITED, Shenzhen (CN)

(72) Inventors: Wenjie DONG, Shenzhen (CN); Weiming FANG, Shenzhen (CN); Bosong ZHAO, Shenzhen (CN)

(73) Assignee: SHENZHEN SMOORE TECHNOLOGY LIMITED, Shenzhen (CN)

(21) Appl. No.: 19/410,109

(22) Filed: Dec. 5, 2025

Related U.S. Application Data
(63) Continuation of application No. PCT/CN2024/081164, filed on Mar. 12, 2024.

(30) Foreign Application Priority Data
Jun. 7, 2023 (CN) 202310668353.8

(51) Int. Cl. A24F 40/57; H05B 1/02

(52) U.S. Cl. CPC A24F 40/57; H05B 1/0227; H05B 2203/021

(57) ABSTRACT

A method for controlling an atomization device, an atomization device, and a non-transitory computer-readable medium are provided. The atomization device includes an atomizer and a battery assembly. The atomizer accommodates an aerosol substrate therein. The atomizer includes a heating element for atomizing the aerosol substrate and a chip storing an atomizer parameter. The chip and the heating element are arranged in parallel and connected to the battery assembly. The battery assembly first detects whether the atomizer is connected. If the atomizer has been connected to the battery assembly, the atomizer parameter is read after a puffing action is detected, and the atomizer is heated based on the atomizer parameter.

### RELATED APPLICATIONS

This application is a continuation application of International application No. PCT/CN2024/081164, filed on March 12, 2024, which claims priority to Chinese Patent Application No. 202310668353.8, filed on June 7, 2023. The entire disclosure of the prior applications is hereby incorporated by reference.

### TECHNICAL FIELD

This disclosure relates to the field of atomization device technologies, including to a method for controlling an atomization device, an atomization device, and a readable storage medium.

### BACKGROUND

A core component of an atomization device includes a battery assembly and an atomizer. After the atomizer is successfully connected to the battery assembly, the battery assembly heats a heating element in the atomizer, causing a temperature of an aerosol substrate accommodated in the atomizer to continuously rise. After an atomization temperature is reached, the aerosol substrate is atomized to generate an aerosol.

After the atomizer is successfully connected to the battery assembly, some data needs to be read to control an operating state of the atomizer. In the conventional technology, during communication between the atomizer and the battery assembly, communication is generally performed when the atomizer is just connected to the battery assembly. However, if the communication is performed in this case, the battery assembly is to heat the heating element of the atomizer, which may generate slight smoke and cause condensate to form inside the atomizer and cause a temperature of the heating element to rise sharply, and may generate slight "pop" noise. This may lead to a poor atomization effect of the subsequent aerosol substrate and affect operating performance of the atomization device.

### SUMMARY

Based on this, in view of the foregoing technical problems, a method for controlling an atomization device, an atomization device, and a readable storage medium capable of improving operating performance are provided.

According to an aspect, this disclosure provides a method for controlling an atomization device.

The atomization device includes an atomizer and a battery assembly. The atomizer accommodates an aerosol substrate therein. The atomizer includes a heating element for atomizing the aerosol substrate and a chip storing an atomizer parameter. The chip and the heating element are arranged in parallel and connected to the battery assembly. The method includes: detecting, by the battery assembly, whether the atomizer is connected to the battery assembly; reading, if the atomizer has been connected to the battery assembly, the atomizer parameter after a puffing action is detected; and heating the atomizer based on the atomizer parameter. In an aspect, the atomizer parameters include a parameter of a first type, and the reading the atomizer parameter after a puffing action is detected includes: reading the parameter of the first type after a first puffing action is detected. In an aspect, the heating the atomizer based on the atomizer parameter includes: heating the atomizer based on the parameter of the first type. In an aspect, the parameter of the first type includes a heating control curve of a heating element.

In an aspect, the atomizer parameter further includes a parameter of a second type, and after the reading the atomizer parameter after a first puffing action is detected, and before the heating the atomizer based on the parameter of the first type, the method further includes: reading the parameter of the second type after a subsequent puffing action is detected, where the subsequent puffing action is a puffing action after the first puffing action. In an aspect, the atomizer parameter further includes a parameter of a second type, and after the heating the atomizer based on the parameter of the first type, the method further includes: reading the parameter of the second type.

In an aspect, an amount of data included in the parameter of the first type is greater than an amount of data included in the parameter of the second type.

In an aspect, a type of the parameter of the first type is different from a type of the parameter of the second type.

In an aspect, the parameter of the first type is a constant value, and the parameter of the second type is a variable value.

In an aspect, the amount of data included in the parameter of the first type refers to a quantity of data types included in the parameter of the first type, and the amount of data included in the parameter of the second type refers to a quantity of data types included in the parameter of the second type.

In an aspect, the amount of data included in the parameter of the second type is less than or equal to 5.

According to an aspect, this disclosure further provides an atomization device. The atomization device includes an atomizer and a battery assembly. The atomizer accommodates an aerosol substrate therein. The atomizer includes a heating element for atomizing an aerosol substrate and a chip storing an atomizer parameter. The chip and the heating element are arranged in parallel and connected to the battery assembly. The battery assembly includes a processor and a memory. The memory is configured to store a computer-readable instruction; and the processor is configured to invoke the computer-readable instruction stored in the memory, to implement the method according to the method in any one of the foregoing embodiments.

According to an aspect, this disclosure further provides a non-transitory computer-readable storage medium, storing instructions which when executed by a processor cause the processor to perform the steps of the method of any one of the foregoing embodiments.

According to the method for controlling an atomization device, the atomization device, and the readable storage medium, the atomization device includes an atomizer and a battery assembly. The atomizer accommodates an aerosol substrate therein. The atomizer includes a heating element for atomizing the aerosol substrate and a chip storing an atomizer parameter. The chip and the heating element are arranged in parallel and connected to the battery assembly. The battery assembly first detects whether the atomizer is connected to the battery assembly. If the atomizer is connected to the battery assembly, the atomizer parameter is read after a puffing action is detected, and the atomizer is heated based on the atomizer parameter. Therefore, the atomizer parameter is not read immediately after the atomizer is connected to the battery assembly. Instead, the atomizer parameter is read after a puffing action is detected, and then the atomizer is heated based on the read atomizer parameter. In this way, airflow generated by the puffing action may be used to carry away smoke generated by heating and reduce condensate generated by the smoke inside the atomizer. In addition, the airflow generated by the puffing action can lower a temperature of the heating element and prevent the temperature of the heating element from rising sharply, thereby helping to ensure an atomization effect of the subsequent aerosol substrate, and improving operating performance of the atomization device.

### BRIEF DESCRIPTION OF THE DRAWINGS

To describe the technical solutions of embodiments of this disclosure or in the related art more clearly, the accompanying drawings required for describing the embodiments or the related art are to be briefly described below. Apparently, the accompanying drawings described below are merely some embodiments of this disclosure, and a person of ordinary skill in the art may further obtain other accompanying drawings according to these accompanying drawings without creative efforts.

FIG. 1 is a schematic flowchart of a method for controlling an atomization device according to an aspect of this disclosure.

FIG. 2 is a schematic flowchart of a method for controlling an atomization device according to another aspect of this disclosure.

FIG. 3 is a schematic flowchart of a method for controlling an atomization device according to still another aspect of this disclosure.

FIG. 4 is a schematic flowchart of a method for controlling an atomization device according to yet another aspect of this disclosure.

FIG. 5 is a schematic flowchart of a method for controlling an atomization device according to an aspect of this disclosure.

FIG. 6 is a schematic flowchart of a method for controlling an atomization device according to an aspect of this disclosure.

FIG. 7 is a schematic structural diagram of an atomization device according to an aspect of this disclosure.

### DETAILED DESCRIPTION

To make objectives, technical solutions, and advantages of this disclosure clearer, this disclosure is further described in detail below with reference to the accompanying drawings and embodiments. It is to be understood that specific embodiments described herein are merely intended to explain this disclosure, and are not intended to limit this disclosure.

A method for controlling an atomization device provided in this disclosure is used to control an atomization device. The atomization device includes an atomizer and a battery assembly. The method for controlling an atomization device may be performed by the battery assembly. The atomizer accommodates an aerosol substrate therein. The atomizer includes a heating element for atomizing the aerosol substrate and a chip storing an atomizer parameter. The chip and the heating element are arranged in parallel and connected to the battery assembly. The chip and the heating element are powered on or off at the same time. Reading data from the chip and controlling the heating element to generate heat cannot be performed separately.

After the atomizer is successfully connected to the battery assembly, the atomizer is powered on. After the atomizer is powered on, a temperature of the heating element in the atomizer starts to rise, causing a temperature of the aerosol substrate accommodated in the atomizer to rise. The aerosol substrate is a substrate that can release, under a certain temperature condition, a volatile compound that may form an aerosol. The aerosol substrate may be a solid or a liquid, or may include solid and liquid components. After the temperature rises to an atomization temperature of the aerosol substrate, the aerosol substrate is atomized to generate an aerosol.

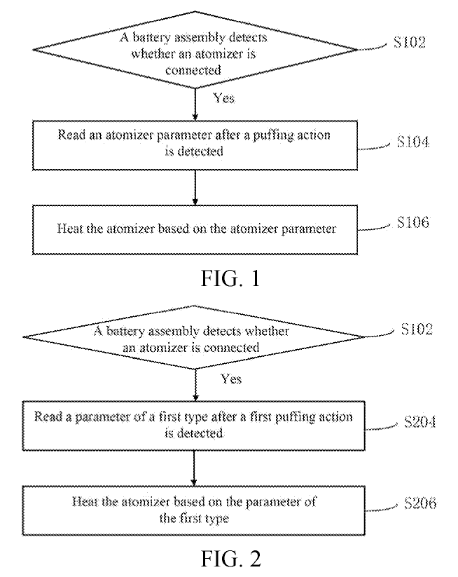

In an aspect, as shown in FIG. 1, a method for controlling an atomization device is provided. A description is provided by using an example in which the method is performed by a battery assembly. The method includes the following steps S102-S106:

Step S102: A battery assembly detects whether an atomizer is connected to the battery assembly.

Exemplarily, the battery assembly detects whether the atomizer is connected. For example, after the battery assembly detects that the atomizer is successfully connected, a flag that has been connected to the atomizer is identified, and it may be determined, by reading a numerical value of the flag, whether the atomizer is connected to the battery assembly.

Step S104: Read, if it is determined that the atomizer has been connected to the battery assembly, an atomizer parameter after a puffing action is detected.

After the atomizer is successfully connected to the battery assembly, it indicates that the atomization device may be in an operating state. In this case, the battery assembly further determines whether the puffing action is detected. A manner in which the battery assembly detects the puffing action is not unique. For example, the atomization device is provided with an air flow sensor. The air flow sensor is connected to the battery assembly. If the user applies a puffing action to the atomization device, the air flow sensor may detect a change of air flow, and send a detection result to the battery assembly. The battery assembly may determine, based on the detection result of the air flow sensor, whether a puffing action is detected.

The battery assembly reads the atomizer parameter after detecting the puffing action. A quantity of atomizer parameters is not limited, and types are not unique either. For example, the atomizer parameter may include a parameter of the heating element, a parameter stored in the chip, a parameter of the battery assembly, or another parameter.

An occasion of reading the parameter is chosen after the puffing action is detected. The air flow generated by the puffing action may be used to remove smoke generated by the battery assembly heating the atomizer when reading the parameter, thereby reducing condensate generated by the smoke in the atomizer. The air flow generated by the puffing action may further be used to lower the temperature of the heating element and suppress a sharp increase in the temperature of the heating element, thereby helping to ensure an atomization effect of the subsequent aerosol substrate, and improving operating performance of the atomization device.

Step S106: Heat the atomizer based on the atomizer parameter.

After the atomizer parameter is obtained, the atomizer may be heated based on the atomizer parameter to implement heating as needed.

In the foregoing method for controlling an atomization device, the atomization device includes an atomizer and a battery assembly. The atomizer accommodates an aerosol substrate therein. The atomizer includes a heating element for atomizing the aerosol substrate and a chip storing atomizer parameters. The chip and the heating element are arranged in parallel and connected to the battery assembly. The battery assembly first detects whether the atomizer is connected. If the atomizer has been connected to the battery assembly, the atomizer parameter is read after a puffing action is detected, and the atomizer is heated based on the atomizer parameter. Therefore, the atomizer parameter is not read immediately after the atomizer is connected to the battery assembly. Instead, the atomizer parameter is read after a puffing action is detected, and then the atomizer is heated based on the read parameter. In this way, airflow generated by the puffing action may be used to carry away smoke generated by heating, thereby reducing condensate generated by the smoke inside the atomizer. In addition, the airflow generated by the puffing action can lower a temperature of the heating element and prevent the temperature of the heating element from rising sharply, thereby helping to ensure an atomization effect of the subsequent aerosol substrate, and improving operating performance of the atomization device.

In an aspect, as shown in FIG. 2, the atomizer parameter includes a parameter of a first type, step S104 may include step S204, and step S106 may include step S206.

Step S204: Read a parameter of a first type after a first puffing action is detected.

The first puffing action refers to a first puffing action detected after the atomization device is turned on. A type of the parameter of the first type is not unique. For example, the parameter of the first type is a heating-related parameter, such as including a heating power, a heating time, a heating frequency, or a temperature correspondence of a heating element. Further, the heating power may also be a heating power curve. The heating time may include a maximum heating time or a heating time curve. The heating frequency may also be a frequency curve. The temperature correspondence of the heating element may be a heating control curve of the heating element, that is, a TCR of the heating element. For example, the parameter of the first type includes the heating control curve of the heating element. The heating control curve of the heating element characterizes a correspondence between a resistance and a temperature of a heating element. When the temperature of the heating element is controlled through the heating control curve of the heating element, the temperature of the heating element may be accurately controlled by adjusting the resistance of the heating element.

Step S206: Heat the atomizer based on the parameter of the first type.

After the parameter of the first type is read, the atomizer is heated based on the parameter of the first type. The current heating may be understood as heating performed in response to the first puffing action. The atomizer is heated based on the parameter of the first type, so that the atomization of the atomization device may satisfy a user requirement more accurately.

In this aspect, the parameter of the first type is read after the first puffing action is detected, and then the atomizer is heated based on the parameter of the first type to implement heating as needed. An occasion of reading the parameter is chosen after the first puffing action is detected. The air flow generated by the first puffing action may be used to remove smoke generated by heating, thereby reducing condensate generated by the smoke in the atomizer. The air flow generated by the first puffing action may further be used to lower the temperature of the heating element and suppress a sharp increase in the temperature of the heating element, thereby helping to ensure an atomization effect of the subsequent aerosol substrate, and improving operating performance of the atomization device. In addition, heating is performed after the parameter of the first type is read, and the subsequent heating process may also be performed as needed.

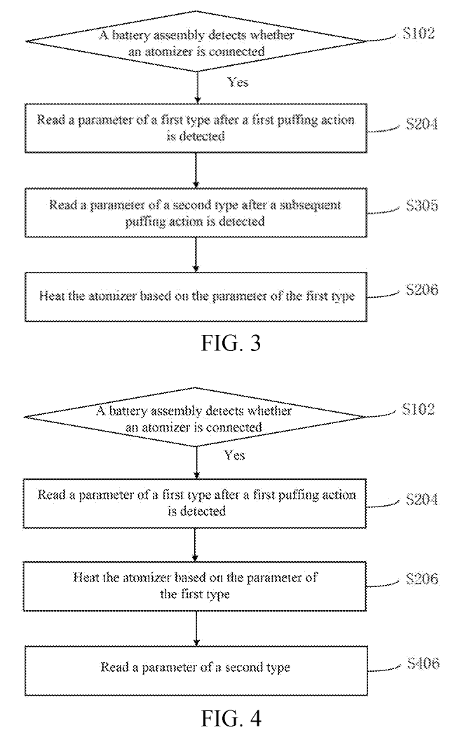

In an aspect, the atomizer parameter further includes a parameter of a second type. As shown in FIG. 3, after step S204 and before step S206, the method for controlling an atomization device further includes step S305.

Step S305: Read a parameter of a second type after a subsequent puffing action is detected.

The subsequent puffing action is a puffing action after the first puffing action. The parameter of the second type includes a parameter different from the parameter of the first type.

After the subsequent puffing action is detected, which may be understood as after each subsequent puffing action is detected, that is, after each puffing action is detected, the parameter of the second type is read once to cause the read parameter of the second type to be more comprehensive. Generally, a detected puffing action corresponds to a puffing action performed by a user. If the user performs continuous puffing actions, and an interval between two adjacent puffing actions is less than a preset time difference threshold, it may also be understood as a single puffing action being detected, thereby reducing workload of reading parameters.

The parameter of the second type may be a parameter related to an operating state of the atomization device. After the subsequent puffing action is detected, the parameter of the second type is read, to facilitate adjustment of the operating state of the atomization device based on the parameter of the second type, thereby reducing an abnormal condition that occurs during the operation of the atomization device, and improving operating reliability of the atomization device. For example, the parameter of the second type includes, but is not limited to, a remaining amount or consumption of an aerosol substrate in the atomizer.

It may be understood that after the subsequent puffing action is detected, the battery assembly heats the atomizer based on each subsequent puffing action. Further, that the atomizer is heated based on the subsequent puffing action means that the atomizer is heated based on the parameter of the first type.

In this aspect, the atomizer parameter includes the parameter of the first type and the parameter of the second type. The parameter of the first type is read after the first puffing action is detected. The parameter of the second type is read after the subsequent puffing action is detected. Therefore, different parameters may be read at different times, thereby reducing a quantity of repeatedly read parameters, and improving communication efficiency.

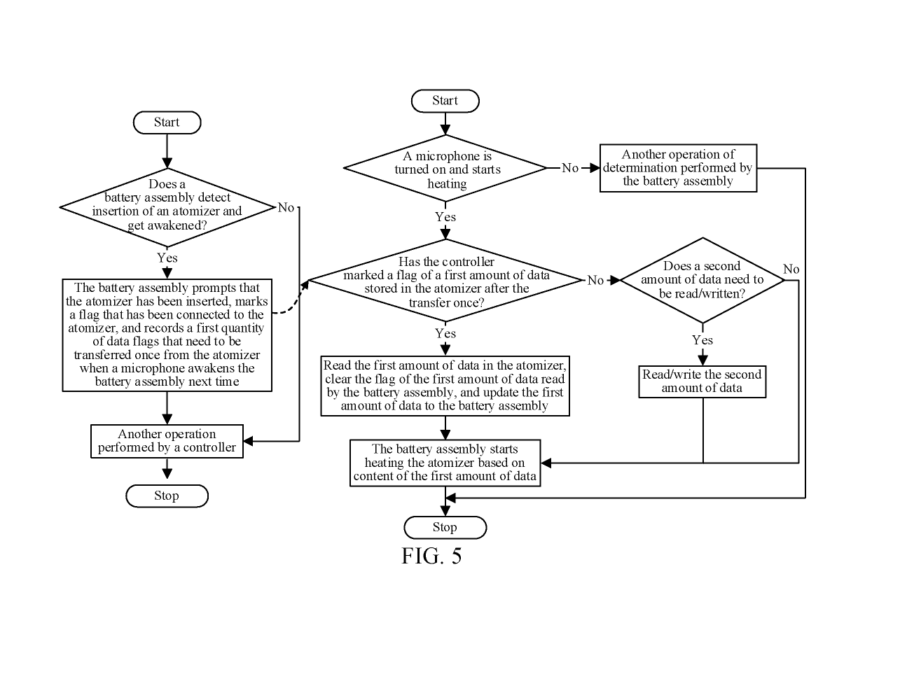

Optionally, in an aspect, the atomizer parameter further includes the parameter of the second type. As shown in FIG. 4, after step S206, the method for controlling an atomization device further includes step S406.

Step S406: Read a parameter of a second type.

In other words, a battery assembly reads the parameter of the first type after detecting a first puffing action, and then heats an atomizer based on the parameter of the first type. The parameter of the second type is read immediately after the atomizer is heated based on the parameter of the first type.

Specifically, the parameter of the second type is read immediately after the atomizer is heated based on the first puffing action and the parameter of the first type, so as to adjust an operating state of each component in the atomization device based on the read parameter of the second type.

It may be understood that the battery assembly heats the atomizer based on each puffing action. Further, that the atomizer is heated based on the subsequent puffing action means that the atomizer is heated based on the parameter of the first type.

In this aspect, the parameter of the second type is read after each puffing action is detected and the heating is completed, to reduce impact of the read parameter on the heating power in an early stage of heating, such as reducing the impact on the heating start time, and also reduce impact on an disclosure with another function.

In the foregoing aspects, optionally, an amount of data included in the parameter of the first type is greater than an amount of data included in the parameter of the second type. The amount of data included in the parameter of the first type refers to a quantity of data types included in the parameter of the first type, and the amount of data included in the parameter of the second type refers to a quantity of data types included in the parameter of the second type. For example, when the parameter of the first type includes a heating power, a heating time, a heating frequency, and a temperature correspondence of a heating element, the amount of data included in the parameter of the first type is 4. When the parameter of the second type includes the consumption of the aerosol substrate, the amount of data included in the parameter of the second type is 1.

Specifically, the parameter of the first type is a parameter read after a first puffing action is detected. The parameter of the second type is a parameter read after a subsequent puffing action is detected. When the amount of data included in the parameter of the first type is greater than the amount of date included in the parameter of the second type, reading of a large amount of data is performed after the first puffing action is detected, and reading of a small amount of data is performed after the subsequent puffing action is detected, which reduces workload of data reading and helps improve communication efficiency.

Further, in an aspect, the amount of data included in the parameter of the second type is less than or equal to 5. For example, the amount of data included in the parameter of the second type may be 1, 2, 3, 4, or 5. Therefore, a relatively small amount of data may be read after the subsequent puffing action is detected, thereby reducing the communication load of an atomization device, and better ensuring normal implementation of other functions of the atomization device.

Optionally, in this aspect, the parameter of the second type includes one or more of time/number of puffs taken from the atomizer, a load resistance value of the atomizer, and the consumption of the aerosol substrate.

In an aspect, the type of the parameter of the first type is different from the type of the parameter of the second type. Therefore, after a first puffing action is detected and after a subsequent puffing action is detected, parameters of different types are respectively read, and different parameters are read at different times, so as to avoid a waste of resources caused by repeated reading of the same parameter, thereby improving the efficiency of data reading.

Further, in an aspect, the parameter of the first type is a constant value, and the parameter of the second type is a variable value. When the parameter of the first type is the constant value, the parameter of the first type basically does not change during the operation of the atomization device. The parameter of the first type is read after a first puff is detected. The parameter of the first type only needs to be read once, and communication is performed once, thereby reducing the communication load.

When the parameter of the second type is the variable value, the parameter of the second type may change during the operation of the atomization device. Subsequently, after each subsequent puffing action is detected, the parameter of the second type is read. The parameter of the second type is read for a plurality of times, and communication is performed for a plurality of times, so that the operating state of the atomization device may be monitored more comprehensively.

To better understand the foregoing aspects, a detailed explanation is provided below with reference to a specific aspect.

In a detailed aspect, the method for controlling an atomization device includes two optional implementations. In a first implementation, when an atomizer is inserted into a battery assembly, the battery assembly does not communicate with an atomizer IC to perform a data reading operation. The atomizer IC is the chip mentioned above. A first amount of data (a parameter of a first type) of the battery assembly and the atomizer IC is read after a first puff and before heating, and communication of the first amount of data is no longer performed during subsequent puffing and heating, thereby reducing impact of data communication on a user. During the subsequent puffing, a second amount of data (a parameter of a second type) is read/written immediately before each puff to reduce smoke and noise of a "puff" caused by lack of air flow during communication at other times.

In a second implementation, when an atomizer is inserted into a battery assembly, the battery assembly does not communicate with an atomizer IC to perform a data reading operation. A first amount of data (a parameter of a first type) of the battery assembly and the atomizer IC is read after a first puff and before heating, and communication of the first amount of data is no longer performed during subsequent puffing and heating, thereby reducing impact of data communication on a user taste. Subsequently, a second amount of data (a parameter of a second type) is read/written immediately after each puff and before heating are completed, so as to reduce impact on each heating power in an early stage when the second amount of data is read/written before the heating, thereby affecting disclosure of other functions. For other functions, for example, for an anti-dry heating function, when the anti-dry heating function needs to be applied, a determination is performed before heating.

It should be noted that the first amount is greater than the second amount, and the second amount is less than or equal to 5.

The first amount of data (the parameter of the first type) includes but is not limited to: a heating power or a power curve, a maximum heating time or a heating time curve, a heating frequency or a frequency curve, a TCR of a heating element, an initial value of a load resistance, an anti-dry heating heat balance value, an anti-dry heating protection value, a load resistance value of an atomizer, a production date, an expiry date/an expiry date, a batch, a serial number/ID of an atomizer, time/number of puffs taken from the atomizer, a maximum time/number of puffs taken from the atomizer, a taste of an aerosol substrate, composition of the aerosol substrate, a maximum amount of e-liquid in the atomizer, an amount/quality of e-liquid from the atomizer, a manufacturer of the aerosol substrate, an aerosol substrate manufacturer, a production plant/production line, or the like.

The second amount of data (the parameter of the second type) includes but is not limited to: time/number of puffs taken from the atomizer, a load resistance of the atomizer, an amount/quality of e-liquid consumed by the atomizer, or the like.

In the first implementation, when the atomizer is inserted into the battery assembly, communication or data reading is not performed. A first amount of data is read after a first puff and before the heating. For a number of subsequent puffs, a second amount of data is read/written as needed after the puffing and before the heating. For details, reference is made to FIG. 5. First, an atomizer is inserted into a battery assembly. If the battery assembly is awakened, a flag that has been connected to the atomizer is identified, and a first quantity of data flags that need to be transferred once from the atomizer when a microphone awakens the battery assembly next time is recoded. If the battery assembly is not awakened, another operation is performed.

In addition, a user performs a puffing action on an atomization device. A sensor detects the puffing action based on air flow outputted from the microphone. If the microphone does not start heating, another operation is performed. If the microphone starts heating, it is determined whether the battery assembly has marked the flag of the first amount of data stored in the atomizer after the transfer once. If the flag has been marked, the first amount of data is read, the flag is cleared (which means that the first amount of data is not read again), then the battery assembly heats the atomizer based on content of the first amount of data, and a communication process is ended. If the flag is not marked, it is determined whether a second amount of data needs to be read/written (each product is different). If the second amount of data needs to be read/written, the second amount of data is read, then the battery assembly heats the atomizer based on content of the first amount of data, and the communication process is ended. If the second amount of data does not need to be read/written, the atomizer is heated directly based on the content of the first amount of data, and then the communication process is ended.

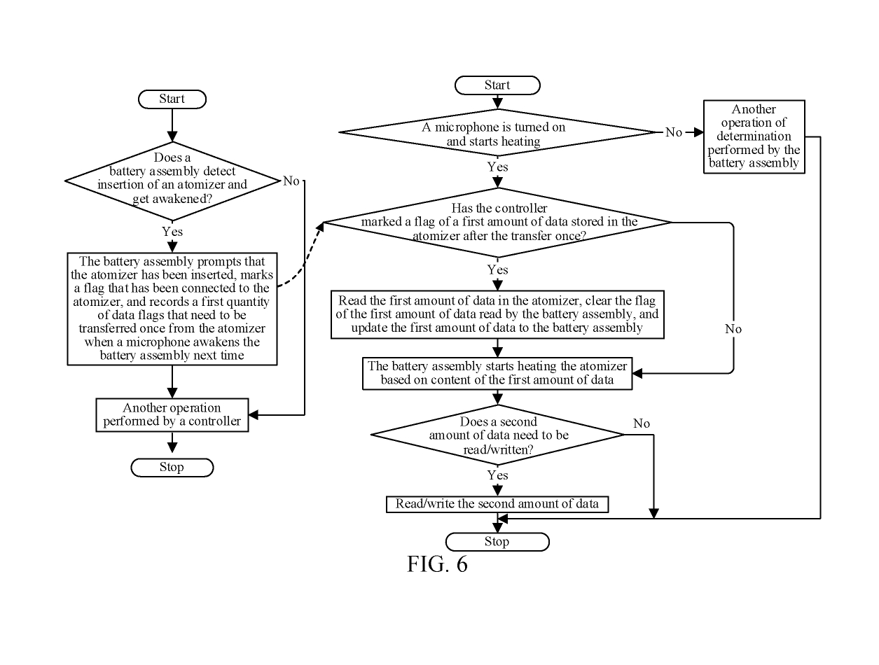

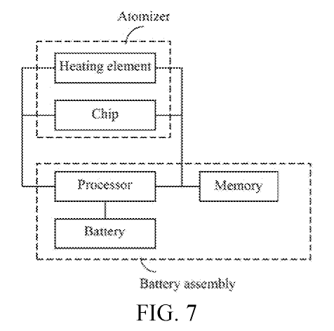

In the second implementation, when the atomizer is inserted into the battery assembly, communication or data reading is not performed. The first amount of data is read after a first puff and before heating. For a number of subsequent puffs, the second amount of data is read/written as needed immediately after puffing and heating. Specifically, as shown in FIG. 6, first, the atomizer is inserted into the battery assembly. If the battery assembly is awakened, a flag that has been connected to the atomizer is identified, and a first quantity of data flags that need to be transferred once from the atomizer when a microphone awakens the battery assembly next time is recoded. If the battery assembly is not awakened, another operation is performed.

In addition, a user performs a puffing action on an atomization device. A sensor detects the puffing action based on air flow outputted from the microphone. If the microphone does not start heating, another operation is performed. If the microphone starts heating, it is determined whether the battery assembly has marked the flag of the first amount of data stored in the atomizer after the transfer once. If the flag has been marked, the first amount of data is read, the flag is cleared (which means that the first amount of data is not read again), then the battery assembly heats the atomizer based on content of the first amount of data, and determines whether the second amount of data needs to be read/written (each product is different). If the second amount of data needs to be read/written, the second amount of data is read, and then the communication process is ended. If the second amount of data does not need to be read/written, the communication process is directly ended.

It should be understood that although the steps in the flowcharts involved in the aspects described above are displayed in sequence as indicated by arrows, these steps are not necessarily performed in sequence as indicated by the arrows. Unless otherwise explicitly specified in this disclosure, execution of the steps is not strictly limited, and the steps may be performed in other sequences. Moreover, at least some of the steps in each aspect may include a plurality of steps or a plurality of stages. The steps or stages are not necessarily performed at the same moment but may be performed at different moments. The steps or stages are not necessarily performed in sequence, but may be performed in turn or alternately with other steps or at least some of steps or stages in other steps.

In an aspect, an atomization device is provided, as shown in FIG. 7, including an atomizer and a battery assembly. The atomizer accommodates an aerosol substrate therein. The atomizer includes a heating element for atomizing an aerosol substrate and a chip storing an atomizer parameter. The chip is arranged in parallel with the heating element, and is connected to the battery assembly; and the battery assembly includes a processor and a memory (e.g., non-transitory computer-readable storage medium). The memory is configured to store a computer-readable instruction, and the processor is configured to invoke the computer-readable instruction stored in the memory, to control the atomization device according to the method in any one of the foregoing aspects. The battery assembly further includes a battery. The battery is connected to the processor, and is configured to provide electric energy for the processor, so that the processor operates normally.

In an aspect, a readable storage medium is provided, having a computer program stored therein, the computer program, when executed by a processor, implementing the steps in any one of the foregoing aspects.

A person of ordinary skill in the art may understand that all or some of processes of the method in the foregoing aspects may be implemented by a computer program instructing relevant hardware. The computer program may be stored in a non-volatile computer-readable storage medium. When the computer program is executed, the processes of the foregoing examples may be implemented. Any reference to a memory, a database, or another medium used in the embodiments provided in this disclosure may include at least one of a non-volatile memory and a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive RAM (MRAM), a ferroelectric RAM (FRAM), a phase change memory (PCM), a graphene memory, and the like. The volatile memory may include a RAM, an external cache, or the like. As a description rather than a limitation, the RAM may have various forms, such as a static RAM (SRAM) or a dynamic RAM (DRAM). The database involved in the embodiments provided in this disclosure may include at least one of a relational database or a non-relational database. The non-relational database may include a blockchain-based distributed database, but is not limited thereto. The processor involved in the embodiments provided in this disclosure may be a general-purpose processor, a central processing unit, a graphics processing unit, a digital signal processor, a programmable logic device, a quantum computing-based data processing logic device, but is not limited thereto.

The technical features of the foregoing embodiments may be combined in different manners. To make the description concise, not all possible combinations of the technical features in the foregoing embodiments are described. However, the combinations of these technical features are considered to fall within the scope recorded in this specification provided that no conflict exists.

The foregoing embodiments merely show some implementations of this disclosure, which are described specifically and in detail, but cannot be construed as a limitation on the patent scope of this disclosure. A person of ordinary skill in the art may make transformations and improvements without departing from the concept of this disclosure. These transformations and improvements fall within the protection scope of this disclosure. Therefore, the protection scope of this disclosure shall be subject to the appended claims.

What is claimed is:

1. A method for controlling an atomization device comprises an atomizer and a battery assembly, the atomizer accommodates an aerosol substrate, the atomizer includes a heating element for atomizing the aerosol substrate and a chip for storing atomizer parameter, the chip and the heating element are arranged in parallel and connected to the battery assembly, and the method comprises:
detecting, by the battery assembly, whether the atomizer is connected to the battery assembly;
reading, if the atomizer has been connected to the battery assembly, the atomizer parameter after a puffing action is detected; and
heating the atomizer based on the atomizer parameter.

2. The method of claim 1, wherein reading the atomizer parameter further comprises:
reading a parameter of a first type after a first puffing action is detected.

3. The method of claim 2, wherein the heating the atomizer further comprises:
heating the atomizer based on the parameter of the first type.

4. The method of claim 2, wherein the parameter of the first type comprises a heating control curve of a heating element.

5. The method of claim 2, wherein
the atomizer parameter further comprises a parameter of a second type, and
after the first puffing action is detected and before the heating the atomizer based on the parameter of the first type, the method further comprises:
reading the parameter of the second type based on a subsequent puffing action is detected, wherein the subsequent puffing action is a puffing action after the first puffing action.

6. The method of claim 2, wherein the atomizer parameter further comprises a parameter of a second type, and after the heating the atomizer based on the parameter of the first type, the method further comprises:
reading the parameter of the second type.

7. The method of claim 5, wherein an amount of data of the parameter of the first type is greater than an amount of data of the parameter of the second type.

8. The method of claim 5, wherein the parameter of the first type is different from the parameter of the second type.

9. The method of claim 5, wherein the parameter of the first type is a constant value, and the parameter of the second type is a variable value.

10. The method of claim 7, wherein the amount of data of the parameter of the first type refers to a quantity of data types of the parameter of the first type, and the amount of data of the parameter of the second type refers to a quantity of data types of the parameter of the second type.

11. The method of claim 10, wherein the amount of data of the parameter of the second type is less than or equal to 5.

12. An atomization device comprising:
an atomizer and a battery assembly, wherein the atomizer accommodates an aerosol substrate, the atomizer comprises a heating element for atomizing the aerosol substrate and a chip storing an atomizer parameter, the chip and the heating element are arranged in parallel and connected to the battery assembly;
the battery assembly is detecting whether the atomizer is connected to the battery assembly;
if the atomizer has been connected to the battery assembly, the atomizer parameter being read after a puffing action is detected; and
the atomizer being heated based on the atomizer parameter.

13. A non-transitory computer-readable storage medium, storing instructions which when executed by a processor cause the processor to perform:
detecting, by the processor, whether an atomizer is connected to a battery assembly;
reading, if the atomizer has been connected to the battery assembly, an atomizer parameter after a puffing action is detected; and
heating the atomizer based on the atomizer parameter.
